(19) United States
(12) Patent Application Publication
(10) Pub. No.: US 2005/0149767 A1
(43) Pub. Date: Jul. 7, 2005

(54) Video and audio control power interface card

(76) Inventor: Dino Fei, Taipei City (TW)

Correspondence Address: CHARLES E. BAXLEY, ESQ., 90 JOHN STREET, THIRD FLOOR, NEW YORK, NY, 10038, US

(21) Appl. No.: 10/747,343

(22) Filed: Dec. 29, 2003

(51) Int. Cl. G06F 1/26

(52) U.S. Cl. 713/300

(57) ABSTRACT

A power interface card includes a processor, an external connecting port, an external power connecting port, an IDE connecting port, and an internal power cord. The internal power cord is connected to a switch device and a plurality of hardware power connectors. Thus, the video and audio access medium is directly driven by the external electric power without needing the electric power from the power supply of the computer host, without having to start the BIOS of the computer, and without needing the source from the mother board.

### BACKGROUND OF THE INVENTION

1. Field of the Invention

The present invention relates to a power interface card, and more particularly to a video and audio control power interface card that is externally connected to an external electric power, so that the video and audio access medium is directly driven by the external electric power without needing the electric power from the power supply of the computer host.

2. Description of the Related Art

A conventional multi-media system integrates the computer, the electric appliance and the communication device, such that the user can arbitrarily start the modes of the TV, Video, Music, Picture, FM, AM, PC or the like so as to watch the TV, DVD and VCD, listen to the music CD, MP3, FM broadcasting, AM broadcasting, and explore the pictures contained in the memory card, etc.

However, the electric power is supplied by the power supply of the computer host, which needs to start the fan of the chassis of the power supply and the fan of the CPU (central processing unit). Thus, the CPU and BIOS (basic input/output system) of the computer are operated simultaneously, and all of the hardware devices are driven and executed by the mother board so as to start the OS (operating system), so that the start operation of the computer takes a long period of time, thereby causing time consumption and causing inconvenience to the user. In addition, operation of the fan of the chassis of the power supply and the fan of the CPU produces louder noise, thereby greatly disturbing the user.

### SUMMARY OF THE INVENTION

The primary objective of the present invention is to provide a power interface card that is externally connected to an external electric power, so that the video and audio access medium is directly driven by the external electric power without needing the electric power from the power supply of the computer host, without having to start the BIOS of the computer, and without needing the source from the mother board.

Another objective of the present invention is to provide a power interface card which is connected to a media connector which is externally connected to an output medium, such as the television, computer monitor or the like, to transmit the signals to the output medium.

A further objective of the present invention is to provide a power interface card that can also receive the electric power from the power supply of the computer host, so that the video and audio access medium directly obtains the electric power from the power supply and is directly driven and used by the mother board.

In accordance with the present invention, there is provided a power interface card, comprising:
a processor;
an external connecting port having a distal end connected to a media connector to transmit a signal to an output medium;
an external power connecting port having a distal end externally connected to an external socket to supply an external electric power;
an IDE (integrated device electronics) connecting port connected to a video and audio access medium;
an internal power cord having a distal end externally connected to a switch device and a plurality of hardware power connectors;
the switch device being connected to a power supply to control an electric power of the power supply and connected to the video and audio access medium to selectively supply the external electric power of the external power connecting port or the electric power of the power supply to the video and audio access medium;
the hardware power connectors being connected to a hardware of the video and audio access medium.

Preferably, the video and audio control power interface card is inserted into a PCI slot formed of the computer housing.

Alternatively, the video and audio control power interface card is an AV (audio/video) adapter which is mounted outside of the computer host, so that the video and audio control power interface card needs not to be inserted into the PCI slot of the mother board. Preferably, the video and audio control power interface card is externally connected to the computer host by a USB (universal serial bus), an IEEE (institution of electrical and electronics engineer) 1384 or 1394 or by other external serial port of the mother board.

Preferably, the video and audio control power interface card is an AV adapter mounted in a floppy disk of a computer host.

Preferably, the composite memory card contains information which is recorded onto a disc in a multi-section manner, so that the disc contains multiple sections or sub-directories, such as 99 sections at the most.

Preferably, the composite memory card contains digital files of JPEG joint photographic expert group), GIF (graphics interchange format) and BMP.

Further benefits and advantages of the present invention will become apparent after a careful reading of the detailed description with appropriate reference to the accompanying drawings.

### BRIEF DESCRIPTION OF THE DRAWINGS

FIG. 1 is a perspective view of a power interface card in accordance with the preferred embodiment of the present invention;

FIG. 2 is a block view of an electric power control of the power interface card in accordance with the preferred embodiment of the present invention;

FIG. 3 is a block view of the power interface card in accordance with the preferred embodiment of the present invention;

FIG. 4 is a block view of the power interface card in accordance with the preferred embodiment of the present invention; and

FIG. 5 is a perspective view showing the power interface card being mounted to a computer.

### DETAILED DESCRIPTION OF THE INVENTION

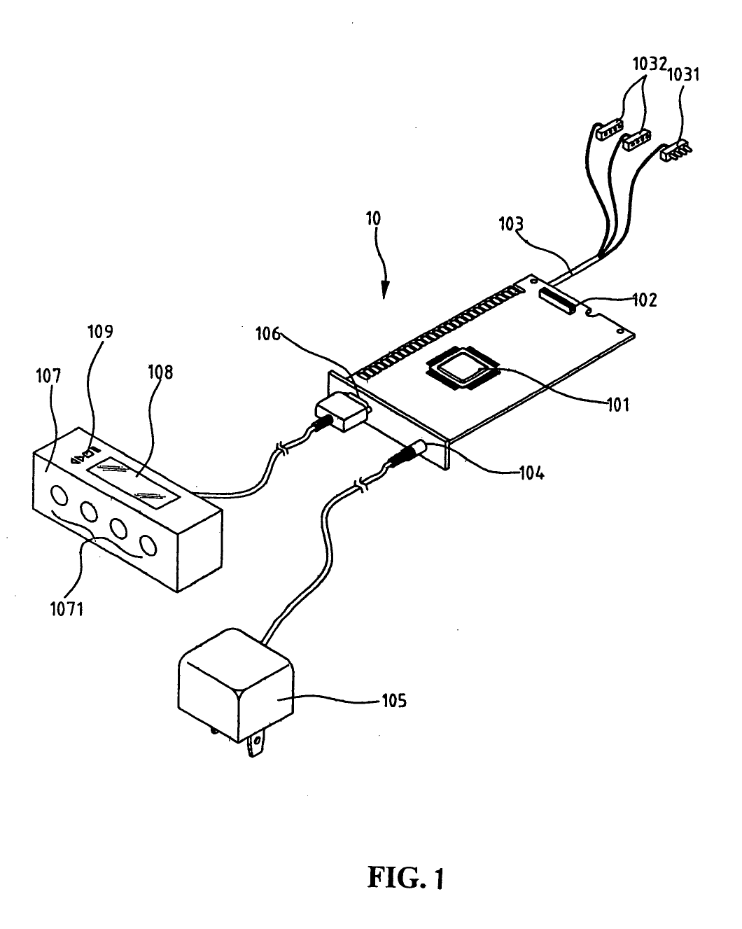

Referring to the drawings and initially to FIG. 1, a video and audio control power interface card in accordance with the preferred embodiment of the present invention comprises a main body 10, a processor 101, an IDE (integrated device electronics) connecting port 102, an internal power cord 103, an external power connecting port 104, and an external connecting port 106.

The processor 101 is mounted on the main body 10. The status of the processor 101 is MPEG de-coder and in-coder plus ARM (Advanced Reduced instruction set computing Machine) CPU if necessary and has the functions of a MPEG (moving picture expert group), such as MPEG1, MPEG2, MPEG3, MPEG4, MPEG7 or the like. In addition, the drive programs of the hardware devices, such as CD-ROM, DVD-ROM, CD-RW (re-writable) (±), DVD-RW(±) or the like, are recorded in the ATAPI (advanced technology attachment package interface).

The IDE connecting port 102 is mounted on the main body 10. A mother board (not shown) has an IDE connecting socket (not shown) connected to an IDE serial line (not shown) and mounted on the IDE connecting port 102. The IDE serial line is connected to a video and audio access medium, such as the CD-ROM, DVD-ROM, CD-RW(±), DVD-RW(±), SVCD, MP3, CD, Photo CD, DV camera playing device, digital camera playing device or the like.

The internal power cord 103 is extended outward from the main body 10 and has a distal end connected to a switch device 1031 and a plurality of hardware power connectors 1032. The internal power cord 103 has an end connected to the power plug (not shown) of a power supply (not shown) of a computer host (not shown), and the hardware power connector 1032 is connected to the video and audio access medium, such as the CD-ROM, DVD-ROM, CD-RW(±), DVD-RW(±), SVCD, MP3, CD, Photo CD or the like, so that the video and audio access medium can obtain multiple electric powers.

The external power connecting port 104 is extended outward from the main body 10 and has a distal end connected to an external socket 105.

The external connecting port 106 is extended outward from the main body 10 and has a distal end connected to a media connector 107. The media connector 107 is provided with a video and audio output port 1071 containing SVHS (super vertical helix scan)/TV, Cable/Antenna Connector, AV (audio video)/SVHS/TV, VGA (video graphic adapter) Monitor, S-Video, Composite/TV, P-Scan (progressive scanning), AV plug, D-sub, DVI (digital video interface) port, scart cable, AM broadcasting, FM broadcasting, Music, Picture or the like. The video and audio output port 1071 is externally connected to an output medium, such as the television, computer monitor or the like, to transmit the signals to the output medium. The media connector 107 has a surface provided with a display panel 108 to facilitate the user exploring the information and messages, and a plurality of functional buttons 109 to facilitate the user switching various functions.

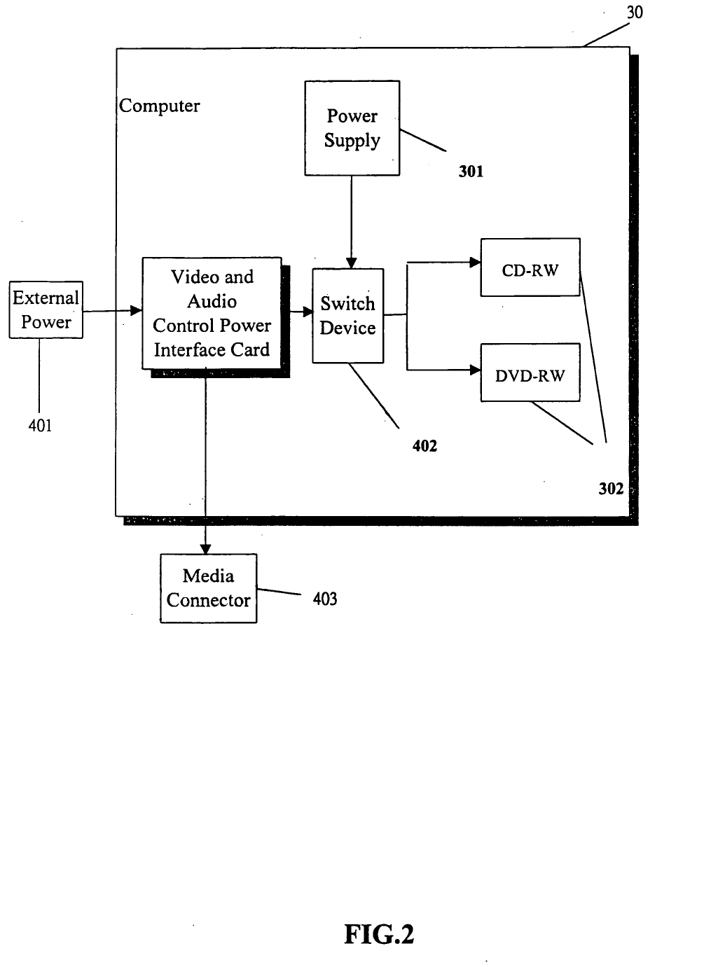

As shown in FIG. 2, the video and audio control power interface card 40 is inserted into the expansion slot (not shown) of the PCI (peripheral component interconnection) interface card (not shown) of a computer host 30. The video and audio control power interface card 40 is externally connected to an external power 401 and a media connector 403. The video and audio control power interface card 40 is connected to a switch device 402 which is connected to a power supply 301 and a video and audio access medium 302.

Thus, the video and audio control power interface card 40 is externally connected to the external power 401 to obtain the external electric power which is directly transmitted through the switch device 402 into the video and audio access medium 302, such as the CD-ROM, DVD-ROM, CD-RW(±), DVD-RW(±), SVCD, MP3, CD, Photo CD or the like, so that the video and audio access medium 302 is directly driven by the external electric power without needing the electric power from the power supply 301 of the computer host 30, without having to start the BIOS (basic input/output system) of the computer, and without needing the source from the mother board (not shown).

Alternatively, the video and audio control power interface card 40 can receive the electric power from the power supply 301 of the computer host 30. In practice, when the computer is started, the external electric power of the external power 401 is cut by controlling the switch device 402 and the video and audio control power interface card 40, and all of the sources are returned to the mother board, so that the video and audio access medium 302, such as the CD-ROM, DVD-ROM, CD-RW(±), DVD-RW(±), SVCD, MP3, CD, Photo CD or the like, directly obtains the electric power from the power supply 301 of the computer host 30. Thus, the video and audio access medium 302 is directly driven and used by the mother board.

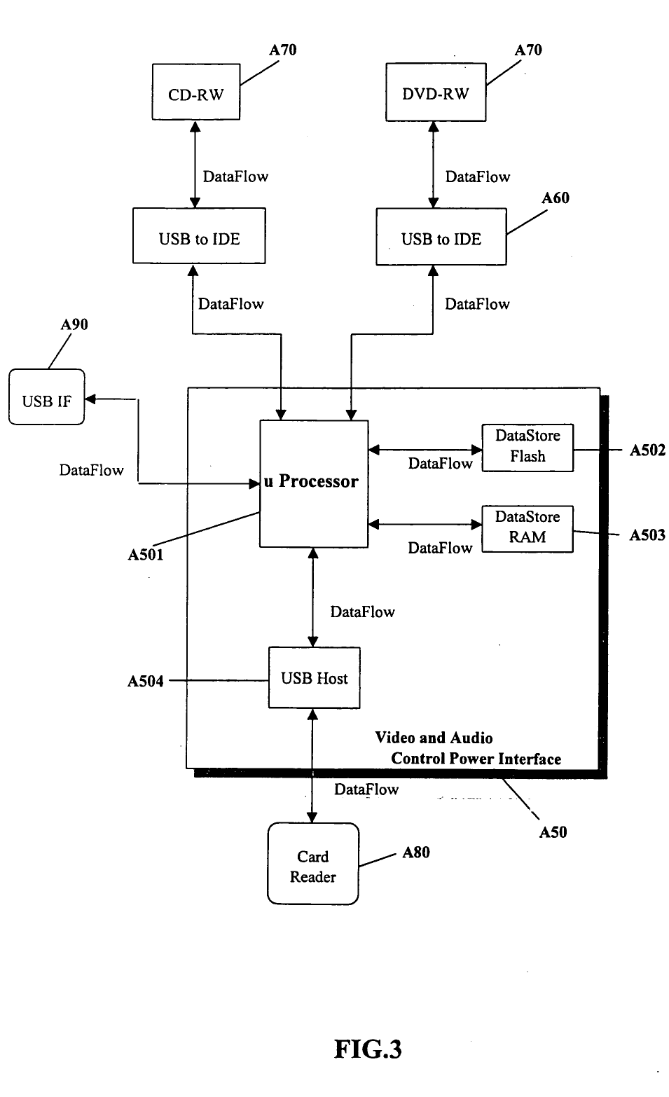

As shown in FIG. 3, the video and audio control power interface card A50 comprises a processor A501, a data store flash A502 connected to the processor A501 to form a data flow transmission, a data store RAM A503 connected to the processor A501 to form a data flow transmission, and a USB (universal serial bus) Host A504 connected to the processor A501 to form a data flow transmission. The USB Host A504 is externally connected to a memory card reader A80 to form a data flow transmission so as to read the data of a composite memory card, such as the smart media card, SD (secure digital) card, MMC (Microsoft management console) card, memory stick card, compact flash card, MD (mini disk) card or the like. In addition, the processor A501 of the video and audio control power interface card A50 is externally connected to a video and audio access medium A70 in a USB-to-IDE switching manner A60 to form a data flow transmission. In addition, the processor A501 of the video and audio control power interface card A50 is externally connected to a media connector (not shown) in a USB IF (implementers forum) manner A90 to form a data flow transmission.

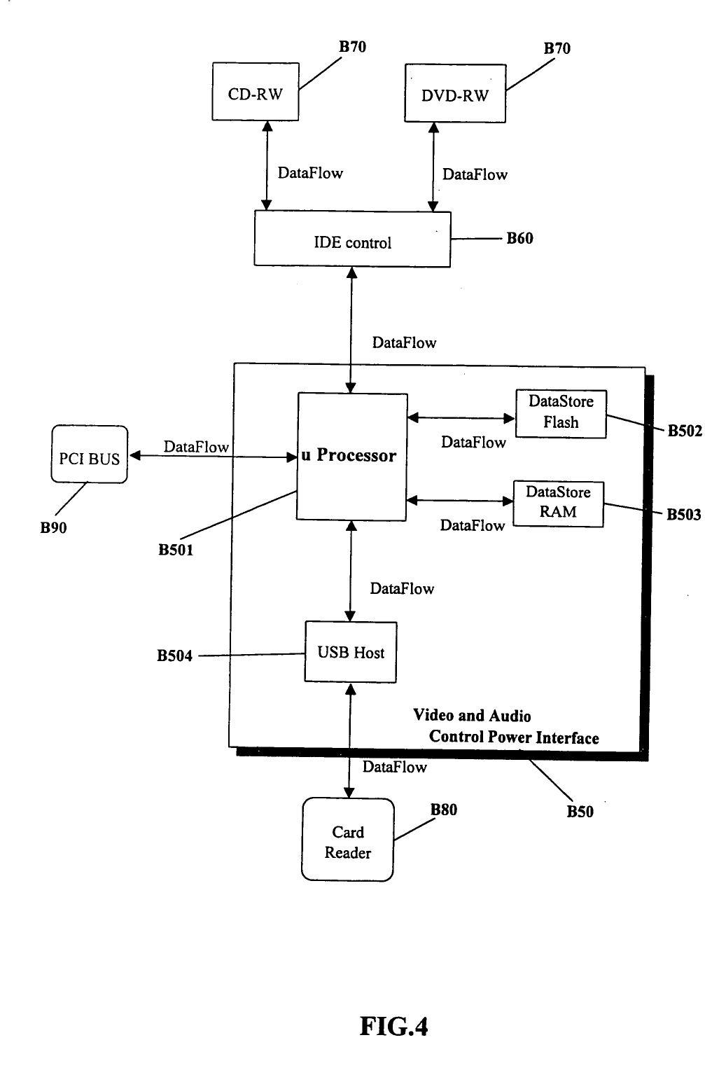

As shown in FIG. 4, the video and audio control power interface card B50 comprises a processor B501, a data store flash B502 connected to the processor B501 to form a data flow transmission, a data store RAM B503 connected to the processor B501 to form a data flow transmission, and a USB Host B504 connected to the processor B501 to form a data flow transmission. The USB Host B504 is externally connected to a memory card reader B80 to form a data flow transmission so as to read the data of a composite memory card, such as the smart media card, SD card, MMC card, memory stick card, compact flash card, MD card or the like. In addition, the processor B501 of the video and audio control power interface card B50 is externally connected to a video and audio access medium B70 in an IDE control manner B60 to form a data flow transmission. In addition, the processor B501 of the video and audio control power interface card B50 is externally connected to a media connector (not shown) in a PCI bus manner B90 to form a data flow transmission.

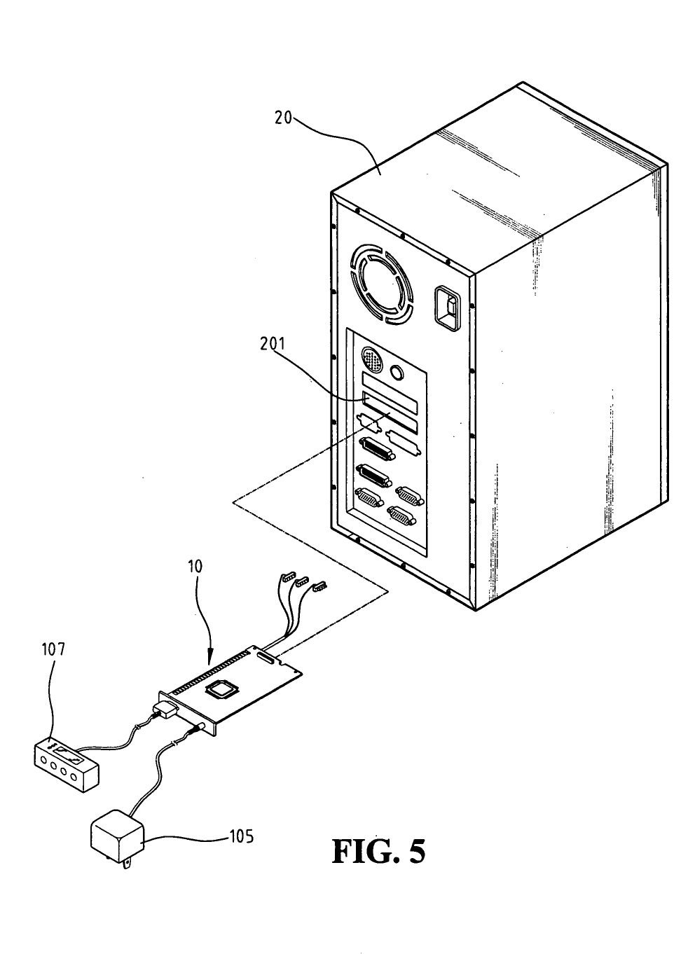

As shown in FIG. 5, the video and audio control power interface card as shown in FIG. 1 is inserted into a PCI slot 201 formed in a rear side of a computer housing 20 and mounted in a mother board.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A power interface card, comprising:
a processor;
an external connecting port having a distal end connected to a media connector to transmit a signal to an output medium;
an external power connecting port having a distal end externally connected to an external socket to supply an external electric power;
an IDE (integrated device electronics) connecting port connected to a video and audio access medium;
an internal power cord having a distal end externally connected to a switch device and a plurality of hardware power connectors;
the switch device being connected to a power supply to control an electric power of the power supply and connected to the video and audio access medium to selectively supply the external electric power of the external power connecting port or the electric power of the power supply to the video and audio access medium;
the hardware power connectors being connected to a hardware of the video and audio access medium.

2. The power interface card in accordance with claim 1, wherein the video and audio control power interface card is inserted into a PCI slot formed of a computer housing.

3. The power interface card in accordance with claim 1, wherein the video and audio control power interface card is an AV adapter mounted outside of a computer host.

4. The power interface card in accordance with claim 1, wherein the video and audio control power interface card is an AV adapter mounted in a floppy disk of a computer host.

5. The power interface card in accordance with claim 1, further comprising a memory card reader and a composite memory card.

6. The power interface card in accordance with claim 5, wherein the composite memory card contains a smart media card, SD (secure digital) card, MMC (Microsoft management console) card, memory stick card, compact flash card and MD (mini disk) card.

7. The power interface card in accordance with claim 5, wherein the composite memory card contains information which is recorded onto a disc in a multi-section manner, so that the disc contains multiple sections or sub-directories.

8. The power interface card in accordance with claim 5, wherein the composite memory card contains digital files of JPEG joint photographic expert group), GIF (graphics interchange format) and BMP.

9. The power interface card in accordance with claim 3, wherein the video and audio control power interface card is externally connected to an external serial port of a mother board in a USB (universal serial bus) manner.

10. The power interface card in accordance with claim 3, wherein the video and audio control power interface card is externally connected to an external serial port of a mother board in an IEEE (institution of electrical and electronics engineer) 1384 manner.

11. The power interface card in accordance with claim 3, wherein the video and audio control power interface card is externally connected to an external serial port of a mother board in an IEEE 1394 manner.

12. The power interface card in accordance with claim 1, wherein the video and audio access medium is a CD-ROM.

13. The power interface card in accordance with claim 1, wherein the video and audio access medium is a DVD-ROM.

14. The power interface card in accordance with claim 1, wherein the video and audio access medium is a CD-RW(±).

15. The power interface card in accordance with claim 1, wherein the video and audio access medium is a DVD-RW(±).

16. The power interface card in accordance with claim 1, wherein the video and audio access medium is a SVCD.

17. The power interface card in accordance with claim 1, wherein the video and audio access medium is a CD.

18. The power interface card in accordance with claim 1, wherein the video and audio access medium is a MP3.

19. The power interface card in accordance with claim 1, wherein the video and audio access medium is a Photo CD.

20. The power interface card in accordance with claim 1, wherein the video and audio access medium is a DV camera playing device.

21. The power interface card in accordance with claim 1, wherein the video and audio access medium is a digital camera playing device.

22. The power interface card in accordance with claim 1, wherein the media connector is externally connected to the external connecting port.

23. The power interface card in accordance with claim 1, wherein the media connector contains a SVHS (super vertical helix scan)/TV, Cable/Antenna Connector, AV (audio video)/SVHS/TV, VGA (video graphic adapter) Monitor, S-Video, Composite/TV, P-Scan (progressive scanning), AV plug, D-sub, DVI (digital video interface) port, scart cable, AM broadcasting, FM broadcasting, Music and Picture.

24. The power interface card in accordance with claim 1, wherein the media connector has a surface provided with a display panel.

25. The power interface card in accordance with claim 1, wherein the media connector has a surface provided with a plurality of functional buttons.

26. The power interface card in accordance with claim 1, wherein the media connector is provided with a video and audio output port.

27. The power interface card in accordance with claim 1, wherein the processor has functions of a MPEG (moving picture expert group), such as MPEG1, MPEG2, MPEG3, MPEG4 and MPEG7.
